(19) United States
(12) Patent Application Publication
(10) Pub. No.: US 2020/0108351 A1
(43) Pub. Date: Apr. 9, 2020

(54) MULTI-LAYERED MEMBRANE FOR OIL/WATER SEPARATION

(71) Applicant: QATAR FOUNDATION FOR EDUCATION, SCIENCE AND COMMUNITY DEVELOPMENT, Doha (QA)

(72) Inventors: ZHAOYANG LIU, DOHA (QA); KUI WANG, DOHA (QA); JAYAPRAKASH SATHTHASIVAM, DOHA (QA); DEMA EL-MASRI, DOHA (QA); NIDAL HILAL, DOHA (QA)

(73) Assignee: QATAR FOUNDATION FOR EDUCATION, SCIENCE AND COMMUNITY DEVELOPMENT, Doha (QA)

(21) Appl. No.: 16/499,856

(22) PCT Filed: Mar. 30, 2017
(86) PCT No.: PCT/QA2017/050001

§ 371 Date: Sep. 30, 2019

(51) Int. Cl. B01D 69/14; B01D 69/12; B01D 71/02; B01D 69/02; B01D 17/00; C02F 1/28; C02F 1/40; B01J 20/20; B01J 20/28

(52) U.S. Cl. CPC B01D 69/147; C02F 2101/32; B01D 71/021; B01D 69/02; B01D 17/085; C02F 1/283; C02F 1/40; B01J 20/20; B01J 20/28004; B01J 20/28038; B01J 20/28057; B01D 2325/04; B01D 2325/12; B01D 2325/36; B01D 2325/38; B01D 69/12

(57) ABSTRACT

The multi-layered membrane (100) for separating oil and water includes a porous top layer (110), a porous bottom layer (130), and a particulate middle layer (120) positioned between the top layer (110) and the bottom layer (130), the middle layer (120) being hydrophobic and adapted for adsorbing oil, such as trace amounts of oil, that may pass through the top layer (110). The top layer (110) and the bottom layer (130) are hydrophilic and oleophobic. While the membrane (100) does not require any external pressure other than the gravitational forces exerted on the oil/water mixture W to drive the filtration of the oil/water mixture W through the membrane (100), the filtration can be driven by a vacuum or other type of external pressure.

### TECHNICAL FIELD

The present invention relates to water filtration, and particularly to a filtration membrane to separate oil from water.

### BACKGROUND ART

The petroleum industry faces a variety of challenges relating to the efficient extraction of oil from water, as well as oils and grease from municipal wastewater. Conventional separation devices and methods, such as gravity separation, skimming, dissolved air floatation, centrifugation, and hydro-cyclone, are either too costly, environmentally unfriendly, energy intensive, and/or low in separation efficiency. For example, liquid chemical dispersant(s) tend to cause secondary environmental pollution, and solid absorbents are limited in their absorption capacity, resulting in additional waste for removal. Cyclone separators normally require high energy input for the oil/water separation process.

Filtration membranes have drawn more attention as a promising technology for the separation of various oil/water mixtures, given their high quality of treated effluents and relatively simple operation process. However, the conventional filtration membranes continue to face the problems of high membrane fouling, incomplete oil/water separation, high energy consumption for operation, and high manufacturing cost. Additionally, these conventional filtration membranes normally suffer from low permeation flux, due to their phase-inversion fabrication process that tends to lead to relatively small pore sizes. Therefore, developing new filtration membranes with high permeation flux, low fouling, and high separation efficiency is critical and highly desirable for treating large amounts of oily wastewater.

Thus, a membrane for oil/water separation solving the aforementioned problems is desired.

### DISCLOSURE OF INVENTION

The multi-layered membrane for separating oil from water can include one or more porous top layers, one or more porous bottom layers, and a middle layer including a particulate material between the one or more top layers and the one or more bottom layers, the middle layer being hydrophobic. The top and bottom layers can be formed from a hydrophilic and oleophobic woven or non woven-fabric. The particulate materials of the middle layer can include hydrophobic or hydrophilic powders. The one or more top layers retain oils, particularly non-emulsified oils, and allows water to pass through. The middle particulate layer adsorbs trace amounts of oil that may pass through the top layer and allows water to pass through. The one or more bottom layers provide mechanical support/strength for the middle layer and the entire membrane. While the membrane does not require any external pressure other than the gravitational forces to filter an oil/water mixture through the membrane, the filtration can be driven by a vacuum or other type of external pressure.

These and other features of the present invention will become readily apparent upon further review of the following specification and drawings.

### BRIEF DESCRIPTION OF DRAWINGS

FIG. 1 illustrates an exploded view of a three-layered membrane for oil and water separation, according to the present invention.

FIG. 2 illustrates an oil/water mixture contacting a top layer of the three-layered membrane for oil/water separation, according to the present invention.

FIG. 3 is an underwater view of the separation of the oil/water mixture, according to the present invention.

FIG. 4 is a graph illustrating the water permeate flux (J, L/m²H) and the oil rejection rate (%) tested with emulsified oil/water mixture (10% oil v/v).

Unless otherwise indicated, similar reference characters denote corresponding features consistently throughout the attached drawings.

### BEST MODES FOR CARRYING OUT THE INVENTION

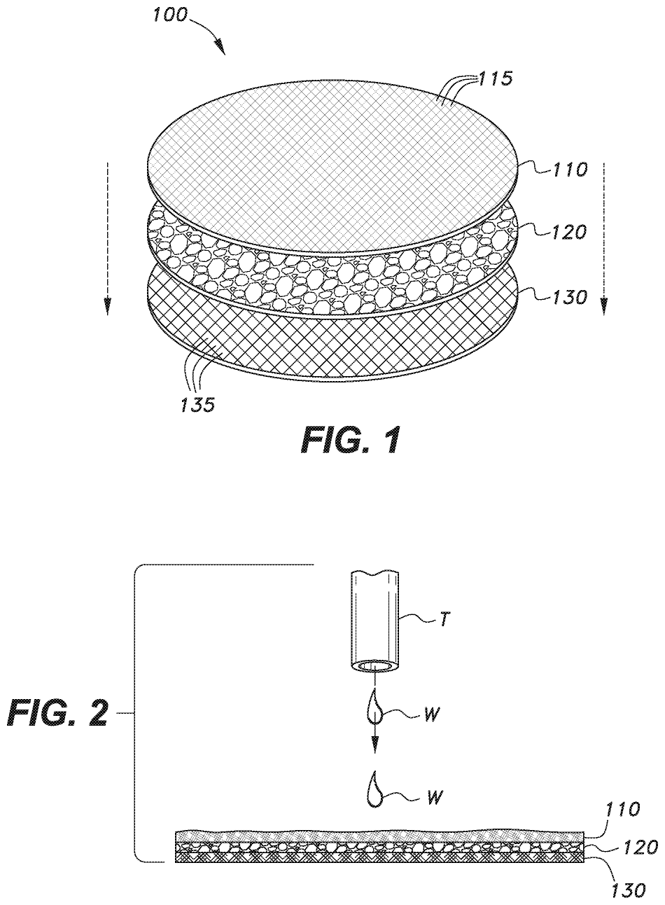

Referring to FIGS. 1 through 4, a multi-layered membrane 100 configured for separating oil from water in an oil/water mixture W, such as from emulsified oil/water mixtures, is generally illustrated. In the embodiment shown, the multi-layered membrane 100 is a three-layered membrane. Herein, the term “membrane” refers to a semi-permeable material that selectively permits water to pass through it while retaining oils on or within the membrane 100. As such, the membrane 100 functions like a filter medium to conduct oil/water separation by selectively allowing water to pass from one side of the membrane 100 to the other side. It is to be noted that the membrane 100 can be a flat sheet membrane, as well as a tubular membrane.

The membrane 100 includes a top layer 110 having a plurality of pores 115, a bottom layer 130 having a plurality of pores 135, and a middle particulate layer 120 positioned between the top layer 110 and the bottom layer 130, the middle layer 120 being hydrophobic and adapted for absorbing oil, such as trace amounts of oil, that passes through the top layer 110. The top layer 110 and bottom layer 130 have hydrophilic and oleophobic fibers. While the membrane 100 does not require any external pressure other than the gravitational forces exerted on the oil/water mixture W to drive the filtration of the oil/water mixture W through the membrane 100, the filtration can be driven by a vacuum or other type of external pressure.

The top layer 110 is configured for retaining an amount of oil from the oil/water mixture W and allowing water to pass (FIG. 2) or permeate through the top layer 110 of the membrane 100. The top layer 110 can retain all or some of the oil in the oil/water mixture W. The top layer 110 can retain non-emulsified oils and emulsified oils that are at least 1 micron in size. It is to be noted that the surface property of the fibers of the top layer 110 can either be intrinsically hydrophilic or turned from hydrophobic into hydrophilic, such as by coating the fiber surfaces of the hydrophobic material with a hydrophilic coating. The hydrophilic and underwater oleophobic properties of the coating materials allow water to flow through the top layer while preventing the oil from the oil/water mixture W to penetrate the top layer 110. The top layer 110 of the membrane 100 can be formed from any suitable material, such as a woven or non-woven fabric material. For example, the top layer 110 can include a micro-sized polymer fabric and, optionally, suitable inorganic particles, such as nanometer-sized inorganic particles. The top layer 110 can have any suitable thickness, such as in the range of between 1 micron and 1000 microns.

The hydrophilic and underwater oleophobic properties of the top layer 110 may make the top layer 110 less subject to oil fouling. The fabric structure of the top layer 110 can also provide high water permeate flux, due to the big pore size (e.g., over 1 micron), while at the same time provide high mechanic strength. It is to be noted, however, that the big pore size of the top layer 110 cannot effectively retain all the oils in the oil/water mixture W, namely the emulsified oils that are smaller than 1 micron in size.

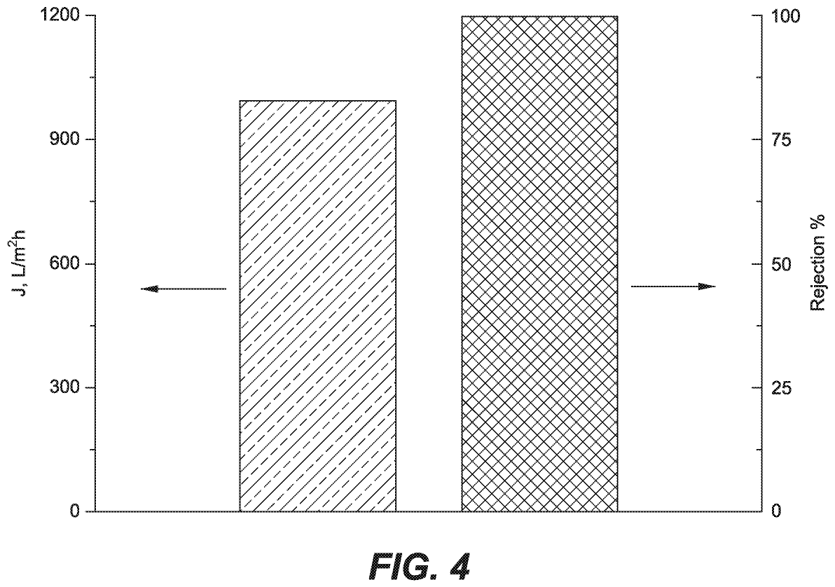

The middle layer 120 includes particulate materials, such as a solid powder. The solid powder can have a dimension of less than 100 microns. and a surface area greater than 10 m²/gram. The middle layer 120 can have a thickness in the ranging from about 1 micron to about 5000 microns. For example, the middle layer 120 can be formed by spreading 0.5 grams of granular activated carbon, such as by a glass rod (not shown), onto the surface of the middle layer 120 having a dimension of 5 cm by 5 cm. The particulate materials used to form the middle layer 120 are adapted for adsorbing trace amounts of oil, such as emulsified oils, that may pass through the top layer 110. As such, the middle layer 120 can aid the membrane 100 in achieving a high oil rejection rate (FIG. 4). The middle layer 120 can absorb oil through capillary force that is similar to conventional foam materials.

The bottom layer 130, positioned beneath the middle layer 120, can include a porous, hydrophilic material. The material can be a woven or a non-woven fabric. The middle layer 120 can have any suitable thickness, such as from about 1 micron to about 1000 microns. The porous material 115 of the bottom layer 130 can include any suitable material, such as a micro-sized polymer fabric and, optionally, suitable inorganic particles, such as nanometer-sized inorganic particles. The main function of the bottom layer 130 is to both provide mechanic support for the middle layer 120, as well as to strengthen the entire membrane 100.

A woven mesh may optionally be included to impart more mechanical strength to the bottom layer 130 while, simultaneously, maintaining a high permeate flux through the membrane 100. It is to be noted that similar to the fibers of the top layer 110, the surface property of the fibers for the bottom layer 130 can either be intrinsically hydrophilic or turned from hydrophobic into hydrophilic, such as by coating the fiber surfaces of the hydrophobic material with a hydrophilic coating.

The membrane 100 can be formed in a various ways. For example, the top layer 110 of the membrane 100 and the bottom layer 130 of the membrane 130 can each be formed by first dissolving about two grams of chitosan, having a degree of deacetylation of 15% (i.e. 95.0%-80.0%), in 100 mL of acetic acid solution (2 wt %) to form a chitosan solution. Subsequently, the chitosan solution is stirred, such as on a magnetic stirrer plate, for approximately twenty-four hours. About 0.1 gram of Polyvinyl alcohol (low molecular weight, PVA) can then be dissolved in 10 ml of deionized (DI) water, such as in a beaker at about 95° C., for approximately twenty-four hours to make a PVA solution (1 wt %). Approximately 10 mL of the PVA solution can be added to 100 mL of the chitosan solution, such as under magnetic stirring, to form a composite solution. Subsequently, 1 gram of TiO₂ nanoparticles (20 nm) can be added to the composite solution, such as under magnetic stirring, to better spread the nanoparticles into the solution uniformly. The composite solution can then be sonicated to remove air bubbles and form a coating solution.

Subsequently, a doctor blade method can be used to cast the coating solution on the fabric of the both the top layer 110 and the bottom layer 120. For example, the coating solution can be poured on the surface of a porous cotton fabric 115, 135. A glass rod (not shown) can be used to manually roll over the surface of the fabric and remove any excess coating solution of the surface of the fabric of each layer 110, 130. The membrane layer can be formed by evenly spreading about 0.5 gram of granular activated carbon onto the surface of the bottom layer using a glass rod. Once the middle layer 120 has been positioned in between the top layer 110 and the bottom layer 130, the membrane 100 can be blow dried.

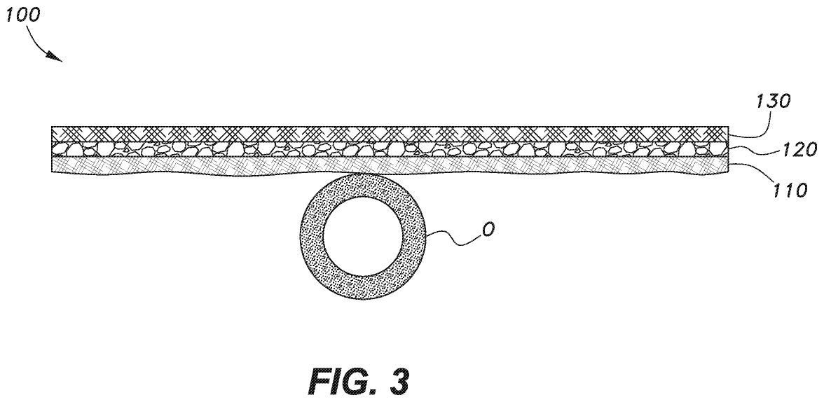

The surface wettability of the membrane 100 was characterized by measuring the water contact angle and the underwater oil contact angle with Rame-hart precision contact angle goniometers. The membrane 100 was fixed between two glass tubes, wherein the top layer 110 of the membrane 100 faced upwards. The oil/water mixture W was made by shaking the oil/water mixture W (10% oil v/v) with vortex under 3000 rpm for 30 seconds. The oil/water mixture W was then poured onto the top layer 110 of the membrane 100, as illustrated in FIG. 2. As illustrated in FIG. 2, the water W contact angle on the top layer 110 of the membrane 100 was approximately 0°, which indicates the top layer 110 of the membrane 100 is super-hydrophilic, and favorable to allow water to pass through while rejecting oil. As illustrated in FIG. 3, the underwater oil (diesel) contact angle on the top layer 110 of the membrane 100 was approximately 150°, which further proves the top layer 110 of the membrane 100 is underwater super-oleophobic, and prone to repel oil 0 from the membrane 100. The separation was driven by gravity on the oil/water mixture W.

After separation, the collected water was removed for oil content analysis. The oil concentration of the collected water after separation was measured by Jorin's Particle Analyzer (Jorin Ltd., Sandhurst, U.K.). Results of the performance tests are shown in FIG. 4. The water permeate flux for the membrane 100 is 980 J, L/m²H, which is much higher than other commercial microfiltration and ultrafiltration membranes, and the oil (diesel) rejection rate reaches approximately 99.9%.

By way of operation, during the oil/water separation process, the oil/water mixture W first contacts the top layer 110 of the membrane 100. The water in the oil/water mixture W will penetrate and flow through the top layer 110 of the membrane 100 while the oil in the oil/water mixture W is retained on or within the membrane 100. As the water passes through the top layer 110, any oil that may pass through the top layer 110 will be retained by the middle layer 120 while water passes through the third layer 130. As mentioned above, the separation process can be driven by gravity, as well as a vacuum or pressure.

It is to be understood that the present invention is not limited to the embodiments described above, but encompasses any and all embodiments within the scope of the following claims.

We claim:

1. A multi-layered membrane for oil and water separation, the membrane comprising:
a top layer having a plurality of pores, the top layer being hydrophilic and oleophobic;
a bottom layer having a plurality of pores, the bottom layer being hydrophilic and oleophobic; and
a middle particulate layer between the top layer and the bottom layer, the middle layer being hydrophobic and adapted for adsorbing oil.

2. The multi-layered membrane for oil and water separation according to claim 1, wherein at least one of the top layer and the bottom layer include a woven fabric.

3. The multi-layered membrane for oil and water separation according to claim 1, wherein at least one of the top layer and the bottom layer include a non-woven fabric.

4. The multi-layered membrane for oil and water separation according to claim 1, wherein the middle layer comprises a solid powder.

5. The multi-layered membrane for oil and water separation according to claim 4, wherein the solid powder comprises granular activated carbon.

6. The multi-layered membrane for oil and water separation according to claim 4, wherein the solid powder has a particle size less than 100 microns in size.

7. The multi-layered membrane for oil and water separation according to claim 4, wherein the solid powder comprises a surface area greater than 10 m²/gram.

8. The multi-layered membrane for oil and water separation according to claim 1, wherein the bottom layer further comprises a woven mesh thereon.

9. The multi-layered membrane for oil and water separation according to claim 1, wherein the top layer includes a plurality of pores having a pore size greater than 1 micron.

10. The multi-layered membrane for oil and water separation according to claim 1, wherein the top layer has a thickness of about 1 micron to about 1000 microns.

11. The multi-layered membrane for oil and water separation according to claim 1, wherein the middle layer has a thickness of about 1 micron to about 5000 microns.

12. The multi-layered membrane for oil and water separation according to claim 1, wherein the bottom layer has a thickness of about 1 micron to about 1000 microns.
